(19) United States
(12) Patent Application Publication
(10) Pub. No.: US 2025/0096252 A1
(43) Pub. Date: Mar. 20, 2025

(54) NEGATIVE ELECTRODE COMPOSITION, NEGATIVE ELECTRODE FOR LITHIUM SECONDARY BATTERY, COMPRISING SAME, AND LITHIUM SECONDARY BATTERY COMPRISING NEGATIVE ELECTRODE

(71) Applicant: LG ENERGY SOLUTION, LTD., Seoul (KR)

(72) Inventors: Jaewook LEE, Daejeon (KR); Dohyeun KIM, Daejeon (KR); Jihee HWANG, Daejeon (KR); Yohan KWON, Daejeon (KR); Donghyuk KIM, Daejeon (KR)

(21) Appl. No.: 18/832,079

(22) PCT Filed: Sep. 21, 2023
(86) PCT No.: PCT/KR2023/014353

§ 371 Date: Jul. 22, 2024

(30) Foreign Application Priority Data
Sep. 21, 2022 (KR) 10-2022-0119283
Sep. 21, 2023 (KR) 10-2023-0126086

(51) Int. Cl. H01M 4/48; H01M 4/02; H01M 4/13; H01M 10/052

(52) U.S. Cl. CPC H01M 4/48; H01M 4/13; H01M 10/052; H01M 2004/021; H01M 2004/027

(57) ABSTRACT

The present disclosure relates to a negative electrode composition, a negative electrode for a lithium secondary battery including the same, and a lithium secondary battery including the negative electrode. The negative electrode composition can include a silicon-based active material, a negative electrode conductive material, and a negative electrode binder, wherein the silicon-based active material comprises 70 parts by weight or more of SiOx (x=0) based on 100 parts by weight of the silicon-based active material, and optionally comprises SiOx (0<x<2), wherein the silicon-based active material has a crystal grain size of 200 nm or less, and wherein the negative electrode conductive material comprises a planar conductive material and a linear conductive material.

### CROSS-REFERENCE TO RELATED APPLICATIONS

The present application is a National Phase entry pursuant to 35 U.S.C. § 371 of International Application No. PCT/KR2023/014353, filed on Sep. 21, 2023, and claims priority to and the benefit of Korean Patent Application No. 10-2022-0119283 filed in the Korean Intellectual Property Office on Sep. 21, 2022, and Korean Patent Application No. 10-2023-0126086 filed in the Korean Intellectual Property Office on Sep. 21, 2023, the entire contents of which are incorporated herein by reference in their entirety for all purposes as if fully set forth herein.

### TECHNICAL FIELD

The present disclosure relates to a negative electrode composition, a negative electrode for a lithium secondary battery including the same, and a lithium secondary battery including the negative electrode.

### BACKGROUND

Due to the rapid increase in the use of fossil fuels, the demand for the use of alternative energy or clean energy is increasing, and as part thereof, the fields that are being studied most actively are the fields of power generation and power storage using an electrochemical reaction.

At present, a secondary battery is a representative example of an electrochemical device that utilizes such electrochemical energy, and the range of use thereof is gradually expanding.

Along with the technological development and the increase in demand for mobile devices, the demand for secondary batteries as an energy source is sharply increasing. Among such secondary batteries, lithium secondary batteries having high energy density and voltage, long cycle life, and low self-discharging rate have been commercialized and widely used. In addition, research is being actively conducted on methods for manufacturing a high-density electrode having a higher energy density per unit volume as an electrode for such a high-capacity lithium secondary battery.

In general, a secondary battery includes a positive electrode, a negative electrode, an electrolyte, and a separator. The negative electrode includes a negative electrode active material for intercalating and deintercalating lithium ions to and from the positive electrode, and silicon-based particles having a high discharge capacity may be used as the negative electrode active material.

In particular, according to the demand for high density energy batteries in recent years, research is being actively conducted into methods for increasing a capacity by using together a silicon-based compound such as Si/C and SiOx having a capacity 10 times or higher than that of a graphite-based material, as a negative electrode active material. However, as compared with graphite that is typically used, a silicon-based compound that is a high-capacity material has a large capacity but can undergo rapid volume expansion during charging, thereby disconnecting a conductive path to degrade battery characteristics.

Accordingly, in order to address problems that may occur when the silicon-based compound is used as the negative electrode active material, methods of suppressing the volume expansion itself such as a method of controlling a driving potential, a method of additionally further coating a thin film on an active material layer and a method of controlling a particle diameter of a silicon-based compound, or various measures for preventing a conductive path from being disconnected have been discussed. However, the above methods may somewhat deteriorate the performance of a battery, and thus, the application thereof is limited, so that there is still a limitation in commercializing the manufacture of a negative electrode battery having a high content of a silicon-based compound.

In addition, when manufacturing a negative electrode by using a silicon-based active material in order to increase energy density, it is difficult to implement sufficient cycle performance by using a small amount of a particulate conductive material such as a carbon-based active material system of the related art due to excessive swelling during charging and discharging. Accordingly, if an excessive amount of particulate conductive material is applied, there is room for improvement in life performance, but there is a limit, and problems of increases in slurry viscosity and amount of gas generation at high temperatures due to the high specific surface area of the particulate conductive material occur.

Therefore, there is a need for research on a conductive material system capable of preventing a conductive path from being damaged due to volume expansion of a silicon-based compound even when the silicon-based compound is used as an active material in order to improve capacity performance, and suitable for a grain silicon-based active material that is a high-capacity negative electrode material.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### RELATED ART

### Japanese Patent Application Publication No. 2009-080971

### SUMMARY

As a result of research on a conductive material system capable of reducing an amount of gas generated at high temperatures in view of the aforementioned problems, it was found that when planar (bulk) and linear conductive materials, instead particulate conductive material, are provided to a silicon-based active material that satisfies a certain crystal grain size, electrical connectivity can be improved and an electrical isolation phenomenon can be prevented.

Accordingly, the present disclosure relates to a negative electrode composition, a negative electrode for a lithium secondary battery including the same, and a lithium secondary battery including a negative electrode.

An exemplary embodiment of the present disclosure provides a negative electrode composition including a silicon-based active material; a negative electrode conductive material; and a negative electrode binder, wherein the silicon-based active material includes 70 parts by weight or more of SiOx (x=0) based on 100 parts by weight of the silicon-based active material, and optionally includes SiOx (0<x<2), wherein the silicon-based active material has a crystal grain size of 200 nm or less, and wherein the negative electrode conductive material includes a planar conductive material and a linear conductive material.

Another exemplary embodiment of the present disclosure provides a negative electrode for a lithium secondary battery including a negative electrode current collector layer; and a negative electrode active material layer including a negative electrode composition according to aspects of the present disclosure formed on at least one surface, such as on only one surface or both surfaces of the negative electrode current collector layer.

Finally, there is provided a lithium secondary battery including a positive electrode; a negative electrode for a lithium secondary battery according to aspects of the present disclosure; a separator provided between the positive electrode and the negative electrode; and an electrolyte.

The negative electrode composition according to an exemplary embodiment of the present disclosure uses the grain silicon-based active material within a specific range to provide for an increase in energy density to fabricate a negative electrode. In this case, according to certain aspects, for the negative electrode conductive material, the planar conductive material and the linear conductive material can be used to greatly improve the electrical connectivity between the silicon-based active materials, which can result in prevention of an electrical isolation phenomenon, which may occur when charging/discharging the negative electrode to which the silicon-based active material is provided, to improve the life of the negative electrode.

According to certain aspects, in the case of negative electrodes for which existing carbon-based active materials are used, a small amount of particulate conductive material can be used as the negative electrode conductive material. However, if such a particulate conductive material is applied to the silicon-based active material according to embodiments of the present disclosure, it can be difficult to implement sufficient cycle performance. According to certain aspects, if an excessive amount of particulate conductive material is included, there can be improvement in life performance, but problems can arise with respect to increases in slurry viscosity and the amount of gas generated at high temperatures due to the high specific surface area. That is, according to certain aspects, a main feature of the negative electrode composition according to embodiments of the present disclosure is that a negative electrode conductive material having a specific composition and content as described above can be provided without using the particulate conductive material, leading to the construction of a system that can be provided together with the silicon-based active material with a high energy density.

### BRIEF DESCRIPTION OF DRAWINGS

FIG. 1 is a view showing a stack structure of a negative electrode for a lithium secondary battery according to an exemplary embodiment of the present disclosure.

FIG. 2 is a view showing a stack structure of a lithium secondary battery according to another exemplary embodiment of the present disclosure.

FIG. 3 is an enlarged view of a silicon-based active material according to an exemplary embodiment of the present disclosure.

### EXPLANATION OF REFERENCE NUMERALS

10: negative electrode current collector layer
10a,b: top and bottom surfaces of negative electrode current collector
20: negative electrode active material layer
30: separator
40: positive electrode active material layer
50: positive electrode current collector layer
100: negative electrode for lithium secondary battery
200: positive electrode for lithium secondary battery

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Before describing aspects and embodiments the present disclosure, some terms are first defined.

When one part “includes”, “comprises” or “has” one constituent element in the present specification, unless otherwise specifically described, this does not mean that another constituent element is excluded, but means that another constituent element may be further included.

In the present specification, ‘p to q’ means a range of ‘p or more and q or less’.

In this specification, the “specific surface area” is measured by the Brunauer-Emmett-Teller (BET) method, and specifically, is calculated from a nitrogen gas adsorption amount at a liquid nitrogen temperature (77K) by using BELSORP-mini II available from BEL Japan, Inc. That is, in the present disclosure, the BET specific surface area may refer to the specific surface area measured by the above measurement method.

In the present specification, “Dn” refers to a particle diameter distribution, and refers to a particle diameter at the n % point in the cumulative distribution of the number of particles according to the particle diameter. That is, D50 is a particle diameter (average particle diameter) at the 50% point in the cumulative distribution of the number of particles according to the particle diameter, D90 is a particle diameter at the 90% point in the cumulative distribution of the number of particles according to the particle diameter, and D10 is a particle diameter at the 10% point in the cumulative distribution of the number of particles according to the particle diameter. Meanwhile, the particle diameter distribution may be measured using a laser diffraction method. Specifically, after powder to be measured is dispersed in a dispersion medium, the resultant dispersion is introduced into a commercially available laser diffraction particle size measurement apparatus (for example, Microtrac S3500) in which a difference in a diffraction pattern according to the particle size is measured, when a laser beam passes through particles, and then a particle size distribution is calculated.

In the present specification, the description “a polymer includes a certain monomer as a monomer unit” means that the monomer participates in a polymerization reaction and is included as a repeating unit in the polymer. In the present specification, when a polymer includes a monomer, this is interpreted as the same as that the polymer includes a monomer as a monomer unit.

In the present specification, it is understood that the term ‘polymer’ is used in a broad sense including a copolymer unless otherwise specified as ‘a homopolymer’.

In the present specification, a weight-average molecular weight (Mw) and a number-average molecular weight (Mn) are polystyrene converted molecular weights measured by gel permeation chromatography (GPC) while employing, as a standard material, a monodispersed polystyrene polymer (standard sample) having various degrees of polymerization commercially available for measuring a molecular weight. In the present specification, a molecular weight refers to a weight-average molecular weight unless particularly described otherwise.

Hereinafter, embodiments of the present disclosure will be described in detail with reference to the drawings so that one skilled in the art can readily implement the present disclosure. However, the present disclosure may be embodied in various different forms, and is not limited to the following descriptions.

An exemplary embodiment of the present disclosure provides a negative electrode composition including a silicon-based active material; a negative electrode conductive material; and a negative electrode binder, wherein the silicon-based active material has a crystal grain size of 200 nm or less, and wherein the negative electrode conductive material includes a planar conductive material and a linear conductive material.

An exemplary embodiment of the present disclosure provides a negative electrode composition including a silicon-based active material; a negative electrode conductive material; and a negative electrode binder, wherein the silicon-based active material includes 70 parts by weight or more of SiOx (x=0) based on 100 parts by weight of the silicon-based active material, and optionally includes SiOx (0<x<2), wherein the silicon-based active material has a crystal grain size of 200 nm or less, and wherein the negative electrode conductive material includes a planar conductive material and a linear conductive material.

In an exemplary embodiment of the present disclosure, there is provided a negative electrode composition in which the silicon-based active material includes includes 70 parts by weight or more of SiOx (x=0) based on 100 parts by weight of the silicon-based active material, and optionally includes SiOx (0<x<2).

In another exemplary embodiment, the silicon-based active material may include SiOx (x=0) in an amount of 70 parts by weight or more, preferably 80 parts by weight or more, and more preferably 90 parts by weight or more, and 100 parts by weight or less, preferably 99 parts by weight or less, and more preferably 95 parts by weight or less on the basis of 100 parts by weight of the silicon-based active material.

In an exemplary embodiment of the present disclosure, for the silicon-based active material, particularly, pure silicon (Si) particles may be used as a silicon-based active material. The use of pure silicon (Si) particles as the silicon-based active material may mean that, based on 100 parts by weight of the total silicon-based active material as described above, pure Si particles (SiOx (x=0)) that is not bonded to other particles or elements are included within the above range.

In an exemplary embodiment of the present disclosure, the silicon-based active material may be composed of silicon-based particles having 100 parts by weight of SiOx (x=0).

In an exemplary embodiment of the present disclosure, the silicon-based active material may include a metal impurity, and in this case, the impurity is metal that may be generally included in the silicon-based active material, and specifically, a content thereof may be 0.1 part by weight or less based on 100 parts by weight of the silicon-based active material.

The capacity of the silicon-based active material is significantly higher than that of a graphite-based active material that is typically used, so that there have been more attempts to use the same. However, the volume expansion rate of the silicon-based active material during charging/discharging is typically high, so that, for example, only a small amount thereof can typically be mixed and used with a graphite-based active material.

However, the negative electrode composition according to aspects of the present disclosure includes a silicon-based active material whose crystal grain size satisfies a range described below and also includes specific planar conductive material and linear conductive material, which can be capable of thereby improving the life performance of the negative electrode and reducing an amount of gas generated at high temperatures.

In an exemplary embodiment of the present disclosure, the crystal grain size of the silicon-based active material may be 200 nm or less.

According to aspects of the present disclosure, the crystal grain size of the silicon-based active material may be 10 nm or greater and 150 nm or less.

In another exemplary embodiment, the crystal grain size of the silicon-based active material may be 200 nm or less, preferably 130 nm or less, more preferably 110 nm or less, still more preferably 100 nm or less, specifically 95 nm or less, and more specifically 91 nm or less. The crystal grain size of the silicon-based active material may have a range of 10 nm or greater, and preferably 15 nm or greater or 30 nm or greater.

According to certain aspects, the silicon-based active material has the crystal grain size described above, and the crystal grain size of the silicon-based active material may be controlled by changing a process condition in a manufacturing process. In this case, according to certain aspects, when the above range is satisfied, the crystal grain boundaries are widely distributed, and thus, the lithium ions can be uniformly intercalated during intercalating of lithium ions, thereby reducing the stress applied during intercalating of lithium ions into the silicon particles, and accordingly, mitigating breakage of the particles. As a result, characteristics capable of improving the life stability of the negative electrode can be obtained. According to certain aspects, if the crystal grain size exceeds the above range, the crystal grain boundaries within the particles are narrowly distributed, and in this case, lithium ions may be non-uniformly intercalated into the particles, which can lead to large stress during the intercalating of ions, and accordingly, breakage of particles.

FIG. 3 is an enlarged view of a silicon-based active material according to an exemplary embodiment of the present disclosure. Specifically, the silicon-based active material 1 is composed of a plurality of crystal structures 2, and in this case, it can be confirmed that the crystal structure has a crystal grain distribution of 1 nm or greater and 200 nm or less. In addition, a space between crystal structures may be defined as a crystal grain boundary. Also, in general, the crystal structure can be expressed as crystal grains.

In an exemplary embodiment of the present disclosure, there is provided a negative electrode active material in which the silicon-based active material includes a crystal structure having a crystal grain distribution of 1 nm or greater and 200 nm or less, and an area ratio of the crystal structure based on a total area of the silicon-based active material is 5% or less.

In another exemplary embodiment, the area ratio of the crystal structure based on the total area of the silicon-based active material may be 5% or less, or 3% or less, and 0.1% or greater.

That is, the silicon-based active material according to aspects of the present disclosure can have a crystal grain size of 200 nm or less, can be formed so that the size of one crystal structure is small, and may satisfy the above area ratio. Accordingly, in certain aspects, the distribution of the crystal grain boundaries may be widened, and accordingly, the above-described effects may be exhibited.

In an exemplary embodiment of the present disclosure, there is provided a negative electrode active material in which the number of the crystal structures included in the silicon-based active material is 20 or more.

In another exemplary embodiment, the number of crystal structures included in the silicon-based active material may satisfy a range of 20 or more, 30 or more, or 35 or more, and 60 or less or 50 or less.

That is, as described above, according to certain aspects, when the crystal grain size of the silicon-based active material satisfies the above range and the number of crystal structures satisfies the above range, the silicon-based active material itself can exhibit strength within an appropriate range. Therefore, according to certain aspects, when such a silicon-based active material is included in an electrode, flexibility can be imparted, and volume expansion can be effectively suppressed.

In the present disclosure, the crystal grain refers to a crystal particle in a metal or material, which is a collection of microscopically irregular shapes, and the crystal grain size may mean a diameter of the observed crystal grain particle. That is, in the present disclosure, the crystal grain size means a size of a domain sharing the same crystal direction in a particle, and is a different concept from a particle size or a size of a particle diameter expressing a size of a material.

In an exemplary embodiment of the present disclosure, the crystal grain size can be calculated as a value of full width at half maximum (FWHM) through x-ray diffraction (XRD) analysis. The remaining values except L are measured through XRD analysis of the silicon-based active material, and the crystal grain size can be measured through the Debey-Scherrer equation showing that the FWHM and the crystal grain size are in inverse ratio. The Debey-Scherrer equation is as shown in Equation 1-1 below.

$$FWHM = K λ / LCos θ \qquad Equation 1 - 1$$

in Equation 1-1,

L is a crystal grain size, K is a constant, θ is a Bragg angle, and λ is a wavelength of X-ray.

In addition, the shapes of the crystal grains are diverse and can be measured in three dimensions. In general, the size of the crystal grain can be measured by a generally used circle method or diameter measurement method, but the present disclosure is not limited thereto.

In the diameter measurement method, the size of the crystal grain can be measured by drawing 5 to 10 parallel lines each having a length of L mm on a micrograph of a target particle, counting the number of crystal grains z on each line, and averaging them. In this case, only crystal grains that are wholly included on the line are counted, and crystal grains that are partially put (laid across) on the line are excluded. If the number of lines is P and the magnification is V, the average particle diameter can be calculated by Equation 1-2 below.

$$Dm = ( L ⋆ P ⋆ {10}^{3} ) / ( zV ) ( um ) \qquad Equation 1 - 2$$

In addition, the circle method is a method in which a circle with a predetermined diameter is drawn on a micrograph of a target particle, and then an average area of crystal grains is calculated by the number of crystal grains in the circle and the number of crystal grains laid across the boundary line, and the average area can be calculated by Equation 1-3 below.

$$Fm = ( Fk ⋆ 1 {0}^{6} ) / ( ( 0.67 n + z ) {V}^{2} ) {um}^{2} \qquad Equation 1 - 3$$

In Equation 1-3, Fm is an average particle area, Fk is a measurement area on the photograph, z is the number of particles in a circle, n is the number of particles laid across the circle, and V is a magnification of a microscope.

In an exemplary embodiment of the present disclosure, a silicon-based active material whose surface area is 0.25 m²/g or greater may be included.

In another exemplary embodiment, the silicon-based active material may have a surface area of 0.25 m²/g or greater, preferably 0.28 m²/g or greater, and more preferably 0.30 m²/g or greater, specifically 0.31 m²/g or greater, and more specifically 0.32 m²/g or greater. The silicon-based active material may satisfy a range of a surface area of 3 m²/g or less, preferably 2.5 m²/g or less, and more preferably 2.2 m²/g or less. The surface area may be measured according to DIN 66131 (using nitrogen).

In an exemplary embodiment of the present disclosure, the negative electrode active material may include a silicon-based active material having a surface area of 0.30 m²/g or greater and 4.00 m²/g or less.

In another exemplary embodiment, the silicon-based active material may have a surface area of 0.30 m²/g or greater, preferably 0.31 m²/g or greater, and more preferably 0.32 m²/g or greater. The silicon-based active material may satisfy a range of a surface area of 4.00 m²/g or less, preferably 2.50 m²/g or less, and more preferably 2.20 m²/g or less.

According to certain aspects, the silicon-based active material has the surface area described above, and the surface area of the silicon-based active material may be controlled by changing a process condition of a manufacturing process and a growth condition of the silicon-based active material. That is, according to certain aspects, when the negative electrode active material is manufactured using the manufacturing method according to the present disclosure, a rough surface results in a larger surface area, as compared with particles with the same particle size. In this case, according to certain aspects, the above range can be satisfied, and thus, the bonding force with the binder can be increased, leading to reduction in cracks of an electrode due to repeating charge and discharge cycles.

In addition, according to certain aspects, the lithium ions can be uniformly intercalated during intercalation of lithium ions, which can result in a reduction in stress applied during intercalation of lithium ions into the silicon particles, and accordingly, reduction in breakage of the particles. As a result, characteristics capable of improving the life stability of the negative electrode are obtained. According to certain aspect, if the surface area is less than the above range, the surface may be smooth even with the same particle size, which can result in a decrease in the bonding force with the binder, and cracks in the electrode. In this case, according to certain aspects, lithium ions may be non-uniformly intercalated into the particles, which can result in an increase in the stress due to the ion intercalation, and breakage of particles.

In an exemplary embodiment of the present disclosure, the silicon-based active material may satisfy a range in Equation 2-1 below.

$$X 1 / Y 1 \leq 0.96 \qquad Equation 2 - 1$$

in Equation 2-1,

X1 refers to an actual area of the silicon-based active material, and

Y1 refers to an area of a spherical particle with the same circumference as the silicon-based active material.

The measurement of Equation 2-1 above may be performed using a particle shape analyzer. Specifically, the silicon-based active material according to the present disclosure may be scattered on a glass plate through air injection, and then a shape of 10,000 silicon-based active material particles in a photograph obtained by capturing a shadow image of the scattered silicon-based active material particles may be measured. In this case, Equation 2-1 is a value expressing an average of 10,000 particles. Equation 2-1 according to the present disclosure can be measured from the above image, and Equation 2-1 can be expressed as sphericity (circularity) of the silicon-based active material. The sphericity may also be expressed by the following Equation: 4π*actual area of silicon-based active material/(circumference)².

In an exemplary embodiment of the present disclosure, the sphericity of the silicon-based active material may be, for example, 0.960 or less, for example, 0.957 or less. The sphericity of the silicon-based active material may be 0.8 or higher, for example, 0.9 or higher, specifically 0.93 or higher, more specifically 0.94 or higher, for example, 0.941 or higher.

In an exemplary embodiment of the present disclosure, the silicon-based active material may satisfy a range in Equation 2-2 below.

$$X 2 / Y 2 \leq 0.996 \qquad Equation 2 - 2$$

in Equation 2-2,

Y2 refers to an actual circumference of the silicon-based active material, and

X2 refers to a circumference of a figure circumscribed to the silicon-based active material.

The measurement of Equation 2-2 above may be performed using a particle shape analyzer. Specifically, the silicon-based active material according to the present disclosure may be scattered on a glass plate through air injection, and then a shape of 10,000 silicon-based active material particles in a photograph obtained by capturing a shadow image of the scattered silicon-based active material particles may be measured. In this case, Equation 2-2 is a value expressing an average of 10,000 particles. Equation 2-2 according to the present disclosure can be measured from the above image, and Equation 2-2 can be expressed as convexity of the silicon-based active material.

In an exemplary embodiment of the present disclosure, a range of X2/Y2≤0.996, preferably X2/Y2≤0.995 may be satisfied, and a range of 0.8≤X2/Y2, preferably 0.9≤X2/Y2, more preferably 0.95≤X2/Y2, specifically 0.98≤X2/Y2 may be satisfied.

The smaller the value of Equation 2-1 or Equation 2-2, the greater the roughness of the silicon-based active material may be meant. According to certain aspects, as the silicon-based active material with the above range is used, the bonding force with the binder can increase, which can lead to a reduction in cracks in the electrode due to the repeating of the charge/discharge cycle.

An average particle diameter (D50) of the silicon-based active material according to aspects of the present disclosure may be 3 μm to 10 μm, specifically 5.5 μm to 8 μm, and more specifically 6 μm to 7 μm. According to certain aspects, when the average particle diameter is within the above range, a specific surface area of the particles may be within a suitable range, so that a viscosity of a negative electrode slurry can be formed within an appropriate range. Accordingly, in certain aspects, the particles constituting the negative electrode slurry can be smoothly dispersed. In addition, according to certain aspects, when the size of the silicon-based active material has a value equal to or greater than the lower limit value of the range, a contact area between the silicon particles and the conductive material may be excellent due to the composite made of the conductive material and the binder in the negative electrode slurry, so that a likelihood of sustaining the conductive network increases, thereby increasing the capacity retention rate. In the meantime, according to certain aspects, when the average particle diameter satisfies the above range, excessively large silicon particles can be excluded, so that a surface of the negative electrode can be formed in a manner that it is smooth. Accordingly, in certain aspects, a current density non-uniformity phenomenon during charging and discharging can be prevented.

In an exemplary embodiment of the present disclosure, the silicon-based active material may be present, for example, in a crystalline or amorphous form, and is preferably not porous. The silicon particles are preferably spherical or splinter-shaped particles. Alternatively, but less preferably, the silicon particles may also have a fiber structure or be present in the form of a silicon-containing film or coating.

In an exemplary embodiment of the present disclosure, there is provided a negative electrode composition in which the silicon-based active material is included in an amount of 60 parts by weight or more based on 100 parts by weight of the negative electrode composition.

In another exemplary embodiment, the silicon-based active material may be included in an amount of 60 parts by weight or more, preferably 65 parts by weight or more, and more preferably 70 parts by weight or more, and 95 parts by weight or less, preferably 90 parts by weight or less, and more preferably 85 parts by weight or less, based on 100 parts by weight of the negative electrode composition.

The negative electrode composition according to aspects of the present disclosure uses the specific conductive material and binder that may be capable of controlling the volume expansion rate during charging and discharging even when the silicon-based active material having a significantly high capacity is used within the above range. Accordingly, in certain aspects, even when the silicon-based active material is within the above range, the negative electrode composition does not degrade the performance of the negative electrode and can have excellent output characteristics in charging and discharging.

In an exemplary embodiment of the present disclosure, the silicon-based active material may have a non-spherical shape and its sphericity (circularity) is, for example, 0.9 or less, for example, 0.7 to 0.9, for example 0.8 to 0.9, and for example 0.85 to 0.9.

In the present disclosure, the circularity is determined by Equation 3-1 below, in which A is an area and P is a boundary line.

$$4 π A / {P}^{2} \qquad Equation 3 - 1$$

In the related art, it is typical to use only graphite-based compounds as the negative electrode active material. However, in recent years, as the demand for high-capacity batteries is increasing, attempts to mix and use silicon-based compounds have been increasing in order to increase capacity. However, the silicon-based compounds can have limitations in that the volume rapidly expands during the charging/discharging, resulting in damage to the conductive path formed in the negative electrode active material layer to degrade the performance of the battery.

Therefore, the negative electrode conductive material according to an exemplary embodiment of the present disclosure may include a planar conductive material and a linear conductive material.

As described above, according to certain aspects, the negative electrode conductive material includes a planar conductive material and a linear conductive material, which can greatly improve electrical connectivity between the silicon-based active material particles, and can prevent isolation of the silicon-based active material particles during charging/discharging to improve the life performance of the negative electrode.

In an exemplary embodiment of the present disclosure, the negative electrode conductive material may include a planar conductive material.

According to certain aspects, the planar conductive material can improve conductivity by increasing surface contact between silicon particles in the negative electrode and at the same time suppress the disconnection of the conductive path due to the volume expansion, and may be expressed as a plate-like conductive material or a bulk-type conductive material.

In an exemplary embodiment of the present disclosure, the planar conductive material may include one or more selected from the group consisting of plate-like graphite, graphene, graphene oxide, and graphite flake, and preferably may be plate-like graphite.

In an exemplary embodiment of the present disclosure, the average particle diameter (D50) of the planar conductive material may be 2 μm to 7 μm, specifically 3 μm to 6 μm, and more specifically 4 μm to 5 μm. According to certain aspects, when the above range is satisfied, a sufficient particle size results in easy dispersion without causing an excessive increase in viscosity of the negative electrode slurry. Therefore, according to certain aspects, the dispersion effect is excellent when dispersing using the same equipment and time.

In an exemplary embodiment of the present disclosure, there is provided a negative electrode composition in which the planar conductive material has D10 of 0.5 μm or greater and 1.5 μm or less, D50 of 2.5 μm or greater and 6.0 μm or less, and D90 of 7.0 μm or greater and 15.0 μm or less.

In an exemplary embodiment of the present disclosure, the planar conductive material may be a graphite-based plate-like material.

In an exemplary embodiment of the present disclosure, for the planar conductive material, a planar conductive material with a high specific surface area having a high BET specific surface area or a planar conductive material with a low specific surface area may be used.

In an exemplary embodiment of the present disclosure, for the planar conductive material, a planar conductive material with a high specific surface area or a planar conductive material with a low specific surface area may be used without limitation. However, in particular, the planar conductive material according to aspects of the present disclosure can be affected to some extent in the electrode performance by the dispersion effect, so that a planar conductive material with a low specific surface area that does not cause a problem in dispersion is used particularly preferably.

In an exemplary embodiment of the present disclosure, the planar conductive material may have a BET specific surface area of 5 m²/g or greater.

In another exemplary embodiment, the planar conductive material may have a BET specific surface area of 5 m²/g or greater and 500 m²/g or less, preferably 5 m²/g or greater and 300 m²/g or less, and more preferably 5 m²/g or greater and 250 m²/g or less.

In another exemplary embodiment, the planar conductive material is a planar conductive material with a high specific surface area, and the BET specific surface area may satisfy a range of 50 m²/g or greater and 500 m²/g or less, preferably 80 m²/g or greater and 300 m²/g or less, and more preferably 100 m²/g or greater and 300 m²/g or less.

In another exemplary embodiment, the planar conductive material is a planar conductive material with a low specific surface area, and the BET specific surface area may satisfy a range of 5 m²/g or greater and 40 m²/g or less, preferably 5 m²/g or greater and 30 m²/g or less, and more preferably 5 m²/g or greater and 25 m²/g or less.

In the present disclosure, a thickness of the planar conductive material may satisfy a range of 0.5 μm or greater and 2 μm or less.

In the present disclosure, the planar conductive material may satisfy a ratio of D50 to the thickness of 20% or greater and 30% or less. In this case, the ratio of D50 to the thickness can be expressed as (thickness of planar conductive material/D50 of planar conductive material)×100%.

According to certain aspects, as the planar conductive material as described above is used, output characteristics at high C-rate are excellent because the life characteristics of the lithium secondary battery are not greatly affected and points where the battery can be charged and discharged are increased.

In an exemplary embodiment of the present disclosure, the linear conductive material may include a linear conductive material such as carbon nanotubes. The carbon nanotubes may be bundle-type carbon nanotubes. The bundle-type carbon nanotubes may include a plurality of carbon nanotube units. Specifically, the term ‘bundle type’ herein refers to, unless otherwise specified, a bundle or rope-shaped secondary shape in which a plurality of carbon nanotube units are aligned side by side in such an orientation that longitudinal axes of the carbon nanotube units are substantially the same, or are entangled. The carbon nanotube unit has a graphite sheet having a cylindrical shape with a nano-sized diameter, and has an sp2 bonding structure. In this case, the characteristics of a conductor or a semiconductor may be exhibited depending on the rolled angle and structure of the graphite sheet. According to certain aspects, as compared with entangled-type carbon nanotubes, the bundle-type carbon nanotubes can be more uniformly dispersed during the manufacture of the negative electrode, and can form more smoothly a conductive network in the negative electrode to improve the conductivity of the negative electrode.

In an exemplary embodiment of the present disclosure, the linear conductive material may be single walled carbon nanotubes (SWCNTs) or multi walled carbon nanotubes (MWCNTs).

In the exemplary embodiment of the present disclosure, the linear conductive material may be SWCNTs.

In an exemplary embodiment of the present disclosure, an average particle diameter of the linear conductive material may be 1 μm or greater and 5 μm or less.

In an exemplary embodiment of the present disclosure, the linear conductive material may have a BET specific surface area of 500 m²/g or greater and 1500 m²/g or less.

In an exemplary embodiment of the present disclosure, a Raman IG/ID of the linear conductive material may satisfy a range of 100 or greater and 150 or less.

The negative electrode conductive material according to an exemplary embodiment of the present disclosure may include 90 parts by weight or more and 99.9 parts by weight or less of the planar conductive material and 0.1 part by weight or more and 10 parts by weight or less of the linear conductive material based on 100 parts by weight of the negative electrode conductive material.

In another exemplary embodiment, the negative electrode conductive material may include 90 parts by weight or more and 99.9 parts by weight or less, preferably 92 parts by weight or more and 99.9 parts by weight or less, and more preferably 93 parts by weight or more and 98 parts by weight or less of the planar conductive material based on 100 parts by weight of the negative electrode conductive material.

In another exemplary embodiment, the negative electrode conductive material may include 0.1 part by weight or more and 10 parts by weight or less, preferably 0.1 part by weight or more and 8 parts by weight or less, and more preferably 0.5 part by weight or more and 7 parts by weight or less of the linear conductive material based on 100 parts by weight of the negative electrode conductive material.

The negative electrode conductive material according to aspects of the present disclosure does not include a particulate conductive material such as carbon black. According to certain aspects, if a particulate conductive material is used, there is room for improvement in life performance, but there is a limit. If an excessive amount of a particulate conductive material is used, according to certain aspects problems can arise in terms of increases in negative electrode slurry viscosity and amount of gas generation at high temperatures due to the high specific surface area of the particulate conductive material.

Accordingly, the negative electrode composition according to aspects of the present disclosure does not use a particulate conductive material, but includes both the planar conductive material and the linear conductive material within the contents described above, which is capable of thereby reducing the viscosity of the negative electrode slurry including the same and the high-temperature gas storage amount.

In an exemplary embodiment of the present disclosure, there is provided the negative electrode composition in which a volume resistance (Ω·cm@1 g/cc) of the linear conductive material is 0.0005 or greater and 0.003 or less.

According to certain aspects, the linear conductive material satisfies the above volume resistance, and can thereby improving the conductivity of the negative electrode including the same. That is, according to certain aspects, it corresponds to a factor representing the electric network maintenance performance of the linear conductive material.

In the exemplary embodiment of the present disclosure, there is provided a negative electrode composition in which the negative electrode conductive material is included in an amount of 10 parts by weight or more and 40 parts by weight or less based on 100 parts by weight of the negative electrode composition.

In another exemplary embodiment, the negative electrode conductive material may be included in an amount of 10 parts by weight or more and 40 parts by weight or less, preferably 10 parts by weight or more and 30 parts by weight or less, and more preferably 15 parts by weight or more and 25 parts by weight or less based on 100 parts by weight of the negative electrode composition.

In an exemplary embodiment of the present disclosure, when the negative electrode conductive material includes the planar conductive material and the linear conductive material and the composition and ratio described above are satisfied, respectively, the life characteristics of an existing lithium secondary battery are not significantly affected, and the number of points where the battery can be charged and discharged increases, so that output characteristics can be excellent at a high C-rate.

In an exemplary embodiment of the present disclosure, the planar conductive material that is used as the negative electrode conductive material described above has a different structure and role from those of the carbon-based active material that is generally used as the negative electrode active material. Specifically, the carbon-based active material that is used as the negative electrode active material may be artificial graphite or natural graphite, and refers to a material that is processed and used into a spherical or particulate shape so as to facilitate storage and release of lithium ions.

On the other hand, according to certain aspects, the planar conductive material that is used as the negative electrode conductive material is a material having a plane or plate-like shape, and may be expressed as plate-like graphite. That is, according to certain aspects, the planar conductive material is a material that is included so as to maintain a conductive path in the negative electrode active material layer, and refers to a material for securing a conductive path in a planar shape inside the negative electrode active material layer, rather than playing a role in storing and releasing lithium.

That is, according to aspects of the present disclosure, the use of plate-like graphite as a negative electrode conductive material means that graphite is processed into a planar or plate-like shape and used as a material for securing a conductive path rather than playing a role in storing or releasing lithium. In this case, according to certain aspects, the negative electrode active material included together is capable of high-capacity characteristics with respect to storing and releasing lithium, and can serve to store and release all lithium ions transferred from the positive electrode.

On the other hand, according to certain aspects, the use of a carbon-based active material as an active material means that the carbon-based active material can be processed into a particulate or spherical shape and used as a material for storing or releasing lithium.

That is, artificial graphite or natural graphite, which is a carbon-based active material, may have a BET specific surface area that satisfies a range of 0.1 m²/g or greater and 4.5 m²/g or less. In addition, plate-like graphite, which is a planar conductive material, has a planar shape, and a BET specific surface area thereof may be 5 m²/g or greater.

The negative electrode conductive material according to aspects of the present disclosure can have a completely different configuration from a conductive material that is applied to the positive electrode. That is, the negative electrode conductive material according to aspects of the present disclosure serves to hold the contact between silicon-based active materials whose volume expansion of the electrode is very large due to charging and discharging, and the positive electrode conductive material serves to impart some conductivity while serving as a buffer when roll-pressed, and is completely different from the negative electrode conductive material of the present disclosure in terms of configuration and role.

In addition, the negative electrode conductive material according to aspects of the present disclosure is provided to a silicon-based active material, and has a completely different configuration from that of a conductive material that is provided to a graphite-based active material. That is, according to certain aspects, since a conductive material that is used for an electrode having a graphite-based active material simply has smaller particles than the active material, the conductive material has characteristics of improving output characteristics and imparting some conductivity, and is completely different from the negative electrode conductive material that is applied together with the silicon-based active material as in the present disclosure, in terms of configuration and role.

In an exemplary embodiment of the present disclosure, the negative electrode binder may include at least one selected from the group consisting of polyvinylidenefluoride-hexafluoropropylene copolymer (PVDF-co-HFP), polyvinylidenefluoride, polyacrylonitrile, polymethylmethacrylate, polyvinyl alcohol, carboxymethylcellulose (CMC), starch, hydroxypropylcellulose, regenerated cellulose, polyvinylpyrrolidone, polytetrafluoroethylene, polyethylene, polypropylene, polyacrylic acid, ethylene-propylene-diene monomer (EPDM), sulfonated EPDM, styrene butadiene rubber (SBR), fluoro rubber, poly acrylic acid, and the above-described materials in which a hydrogen is substituted with Li, Na, Ca, etc., and may also include various copolymers thereof.

The negative electrode binder according to an exemplary embodiment of the present disclosure serves to hold the active material and the conductive material in order to prevent distortion and structural deformation of the negative electrode structure during volume expansion and relaxation of the silicon-based active material. When such roles are satisfied, all of the general binders can be applied. Specifically, an aqueous binder may be used, and more specifically, a polyacrylamide (PAM)-based binder may be used.

In an exemplary embodiment of the present disclosure, the negative electrode binder may be included in an amount of 30 parts by weight or less, preferably 25 parts by weight or less, and more preferably 20 parts by weight or less, and 5 parts by weight or more, or 10 parts by weight or more, based on 100 parts by weight of the negative electrode composition.

Compared to existing carbon-based negative electrodes, according to certain aspects, when a Si-based negative electrode is used, an aqueous binder is provided in parts by weight described above, allowing the use of a negative electrode conductive material with a low functional group content. In addition, according to certain aspects, the above characteristics can allow the negative electrode conductive material to have hydrophobicity and the excellent bond strength between the conductive material/binder.

In an exemplary embodiment of the present disclosure, there is provided a negative electrode for a lithium secondary battery including: a negative electrode current collector layer; and a negative electrode active material layer including the negative electrode composition according to the present disclosure formed on at least one surface, such as only one surface or both surfaces, of the negative electrode current collector layer.

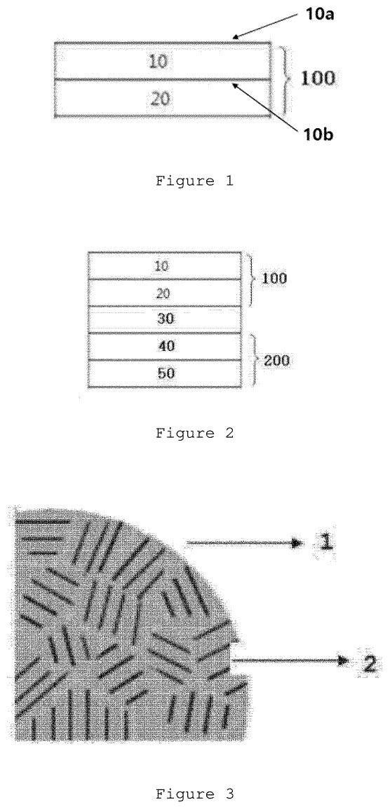

FIG. 1 is a view showing a stack structure of a negative electrode for a lithium secondary battery according to an exemplary embodiment of the present disclosure. Specifically, a negative electrode 100 for a lithium secondary battery can be seen which includes a negative electrode active material layer 20 on one surface of a negative electrode current collector layer 10. FIG. 1 shows that the negative electrode active material layer is formed on one surface of the negative electrode current collector layer, but the negative electrode active material layer may also be formed on both surfaces of the negative electrode current collector layer.

In an exemplary embodiment of the present disclosure, the negative electrode current collector layer generally has a thickness of 1 μm to 100 μm. Such a negative electrode current collector layer is not particularly limited as long as it has high conductivity without causing a chemical change in the battery. For example, copper, stainless steel, aluminum, nickel, titanium, fired carbon, copper or stainless steel each surface-treated with carbon, nickel, titanium, silver, or the like, an aluminum-cadmium alloy, or the like may be used. In addition, the negative electrode current collector layer may have microscopic irregularities formed on a surface to enhance a bonding force of the negative electrode active material, and may be used in various forms such as a film, a sheet, a foil, a net, a porous body, a foamed body, or a non-woven fabric body.

In an exemplary embodiment of the present disclosure, a negative electrode for a lithium secondary battery may be formed by applying and drying a negative electrode slurry including the negative electrode composition to one surface or both surfaces of the negative electrode current collector layer.

In an exemplary embodiment of the present disclosure, there is provided a negative electrode composition in which the viscosity of the negative electrode composition is 1,000 cP or higher and 6,000 cP or less.

In this case, the negative electrode slurry may include the negative electrode composition described above, and a slurry solvent.

In an exemplary embodiment of the present disclosure, a solid content of the negative electrode slurry may satisfy a range of 5% or more and 40% or less.

In another exemplary embodiment, the solid content of the negative electrode slurry may satisfy a range of 5% or more and 40% or less, preferably 7% or more and 35% or less, and more preferably 10% or more and 30% or less.

The solid content of the negative electrode slurry may mean a content of the negative electrode composition included in the negative electrode slurry, and may mean a content of the negative electrode composition on the basis of 100 parts by weight of the negative electrode slurry.

When the solid content of the negative electrode slurry satisfies the above range, according to certain aspects, the viscosity may be appropriate during formation of the negative electrode active material layer, so that particle aggregation of the negative electrode composition is minimized to efficiently form the negative electrode active material layer. In addition, according to certain aspects, as the negative electrode composition includes the specific conductive material described above, the increase in viscosity can be suppressed and the dispersibility of the negative electrode slurry can be improved.

In an exemplary embodiment of the present disclosure, the viscosity of the negative electrode slurry may be 1,000 cP or higher and 8,000 cP or less.

In another exemplary embodiment, the viscosity of the negative electrode slurry may satisfy a range of 1,000 cP or higher and 8,000 cP or less, preferably 1,500 cP or higher and 6,000 cP or less, and more preferably 2,000 cP or higher and 4,000 cP or less.

In an exemplary embodiment of the present disclosure, there is provided a negative electrode for a lithium secondary battery in which a thickness of the negative electrode current collector layer is 1 μm or greater and 100 μm or less and a thickness of the negative electrode active material layer is 20 μm or greater and 500 μm or less.

However, the thickness may be variously modified depending on a type and use of the negative electrode used, and is not limited thereto.

In an exemplary embodiment of the present disclosure, a porosity of the negative electrode active material layer may satisfy a range of 10% or greater and 60% or less.

In another exemplary embodiment, the porosity of the negative electrode active material layer may satisfy a range of 10% or greater and 60% or less, preferably 20% or greater and 50% or less, and more preferably 30% or greater and 45% or less.

According to certain aspects, the porosity may vary depending on compositions and contents of the silicon-based active material, conductive material and binder included in the negative electrode active material layer, and in particular, it may satisfy the range described above when the silicon-based active material according to the present disclosure and the conductive material are included in the specific compositions and contents, so that the electrode has electrical conductivity and resistance within appropriate ranges.

An exemplary embodiment of the present disclosure provides a lithium secondary battery including a positive electrode; a negative electrode for a lithium secondary battery according to aspects of the present disclosure; a separator provided between the positive electrode and the negative electrode; and an electrolyte.

FIG. 2 is a view showing a stack structure of a lithium secondary battery according to another exemplary embodiment of the present disclosure. Specifically, a negative electrode 100 for a lithium secondary battery including a negative electrode active material layer 20 on one surface of a negative electrode current collector layer 10 can be seen, a positive electrode 200 for a lithium secondary battery including a positive electrode active material layer 40 on one surface of a positive electrode current collector layer 50 can be seen, and the negative electrode 100 for a lithium secondary battery and the positive electrode 200 for a lithium secondary battery are formed in a stack structure with a separator 30 interposed therebetween.

The secondary battery according to an exemplary embodiment of the present disclosure may particularly include the negative electrode for a lithium secondary battery according to aspects described above. Specifically, the secondary battery may include a negative electrode, a positive electrode, a separator interposed between the positive electrode and the negative electrode, and an electrolyte, and the negative electrode is the same as the negative electrode described in the embodiments and aspects above. Since the negative electrode has been described above, a detailed description thereof is omitted.

The positive electrode may include a positive electrode current collector and a positive electrode active material layer formed on the positive electrode current collector and including the positive electrode active material.

In the positive electrode, the positive electrode current collector is not particularly limited as long as it has conductivity without causing a chemical change in the battery. For example, stainless steel, aluminum, nickel, titanium, fired carbon, aluminum or stainless steel each surface-treated with carbon, nickel, titanium, silver, or the like, or the like may be used. In addition, the positive electrode current collector may typically have a thickness of 3 to 500 μm, and a surface of the current collector may be formed with microscopic irregularities to enhance adhesion of the positive electrode active material. For example, the positive electrode current collector may be used in various forms such as a film, a sheet, a foil, a net, a porous body, a foamed body, and a non-woven fabric body.

The positive electrode active material may be a positive electrode active material that is typically used. Specifically, the positive electrode active material may be a layered compound such as a lithium cobalt oxide (LiCoO₂) and a lithium nickel oxide (LiNiO₂), or a compound substituted with one or more transition metals; a lithium iron oxide such as LiFe₃O₄; a lithium manganese oxide such as chemical formula Li_{1+c1}Mn_{2-c1}O₄ (0≤c1≤0.33), LiMnO₃, LiMn₂O₃ and LiMnO₂; a lithium copper oxide (Li₂CuO₂); a vanadium oxide such as LiV₃O₈, V₂O₅ and Cu₂V₂O₇; Ni-site type lithium nickel oxide represented by chemical formula LiNi_{1-c2}M_{c2}O₂ (where M is at least one selected from the group consisting of Co, Mn, Al, Cu, Fe, Mg, B, and Ga, and satisfies 0.01≤c2≤0.6); a lithium manganese composite oxide represented by chemical formula LiMn_{2-c3}M_{c3}O₂ (where M is at least one selected from the group consisting of Co, Ni, Fe, Cr, Zn and Ta, and satisfies 0.01≤c3≤0.6) or Li₂Mn₃MO₈ (where M is at least one selected from the group consisting of Fe, Co, Ni, Cu and Zn); LiMn₂O₄ in which a part of Li of the chemical formula is substituted with an alkaline earth metal ion, or the like, but is not limited thereto. The positive electrode may be Li metal.

In the exemplary embodiment of the present disclosure, the positive electrode active material includes a lithium composite transition metal compound including nickel (Ni), cobalt (Co), and manganese (Mn), the lithium composite transition metal compound includes single particles or secondary particles, and an average particle diameter (D50) of the single particles may be 1 μm or greater.

For example, the average particle diameter (D50) of the single particles may be 1 μm or greater and 12 μm or less, 1 μm or greater and 8 μm or less, 1 μm or greater and 6 μm or less, greater than 1 μm and 12 μm or less, greater than 1 μm and 8 μm or less, or greater than 1 μm and 6 μm or less.

Even when the single particles are formed with a small average particle diameter (D50) of 1 μm or greater and 12 μm or less, the particle strength may be excellent. For example, the single particle may have a particle strength of 100 to 300 MPa when roll-pressing with a force of 650 kgf/cm². Accordingly, even when the single particles are roll-pressed with a strong force of 650 kgf/cm², the increase phenomenon of micro-particles in an electrode due to particle breakage is alleviated, thereby improving the lifetime characteristic of the battery.

The single particles may be manufactured by mixing and firing a transition metal precursor and a lithium source material. The secondary particles may be manufactured by a method that is different from that of the single particles, and the composition thereof may be the same as or different from that of the single particles.

The method of forming the single particles is not particularly limited, but generally can be formed by over-firing with raised firing temperature, or may be manufactured by using additives such as grain growth promoters that help over-firing, or by changing a starting material.

For example, firing can be performed at a temperature at which single particles can be formed. To this end, firing can be performed at a temperature higher than a temperature used during manufacture of the secondary particles. For example, when the composition of the precursor is the same, firing can be performed at a temperature about 30° C. to 100° C. higher than a temperature used during manufacture of the secondary particles. The firing temperature for forming the single particles may vary depending on the metal composition in the precursor. For example, when forming single particles with a high-Ni nickel-cobalt-manganese (NCM)-based lithium composite transition metal oxide having a nickel (Ni) content of 80 mol % or more, the firing temperature may be about 700° C. to 1000° C., and preferably about 800° C. to 950° C. According to certain aspects, when the firing temperature satisfies the above range, a positive electrode active material including single particles having excellent electrochemical properties can be manufactured. According to certain aspects, if the firing temperature is below 790° C., a positive electrode active material including a lithium composite transition metal compound in the form of secondary particles may be manufactured, and if the firing temperature exceeds 950° C., excessive firing can occur and a layered crystal structure may not be properly formed, so that the electrochemical properties may be deteriorated.

In the present disclosure, single particle is a term used to distinguish the same from typical secondary particles resulting from aggregation of tens to hundreds of primary particles, and is a concept including a single particle consisting of one primary particle and a quasi-single particle form that is an aggregate of 30 or less primary particles.

Specifically, in the present disclosure, the single particle may be a single particle consisting of one primary particle or a quasi-single particle form that is an aggregate of 30 or less primary particles, and the secondary particle may be an aggregate form of hundreds of primary particles.

In the exemplary embodiment of the present disclosure, the lithium composite transition metal compound, which is the positive electrode active material, further includes secondary particles, and the average particle diameter (D50) of the single particles is smaller than the average particle diameter (D50) of the secondary particles.

In the present disclosure, the single particle may be a single particle consisting of one primary particle or a quasi-single particle form that is an aggregate of 30 or less primary particles, and the secondary particle may be an aggregate form of hundreds of primary particles.

The above-described lithium composite transition metal compound may further include secondary particles. The secondary particle means a form formed by aggregation of primary particles, and can be distinguished from the concept of a single particle including one primary particle, one single particle and a quasi-single particle form, which is an aggregate of 30 or less primary particles.

The secondary particle may have a particle diameter (D50) of 1 μm to 20 μm, 2 μm to 17 μm, and preferably 3 μm to 15 μm. The specific surface area (BET) of the secondary particles may be 0.05 m²/g to 10 m²/g, preferably 0.1 m²/g to 1 m²/g, and more preferably 0.3 m²/g to 0.8 m²/g.

In a further exemplary embodiment of the present disclosure, the secondary particle is an aggregate of primary particles, and the average particle diameter (D50) of the primary particles is 0.5 μm to 3 μm. Specifically, the secondary particle may be an aggregate form of hundreds of primary particles, and the average particle diameter (D50) of the primary particles may be 0.6 μm to 2.8 μm, 0.8 μm to 2.5 μm, or 0.8 μm to 1.5μ m.

According to certain aspects, when the average particle diameter (D50) of the primary particles satisfies the above range, a single-particle positive electrode active material having excellent electrochemical properties can be formed. If the average particle diameter (D50) of the primary particles is too small, according to certain aspects, the number of aggregates of primary particles forming lithium nickel-based oxide particles can increase, reducing the effect of suppressing particle breakage during roll-pressing, and if the average particle diameter (D50) of the primary particles is too large, according to certain aspects, a lithium diffusion path inside the primary particles may be lengthened, increasing a resistance and degrading an output characteristic.

According to a further exemplary embodiment of the present disclosure, the average particle diameter (D50) of the single particles is smaller than the average particle diameter (D50) of the secondary particles. As a result, according to certain aspects, the single particles may have excellent particle strength even if they are formed with a small particle diameter, and accordingly, the increase the phenomenon of micro-particles in an electrode due to particle breakage is alleviated, thereby improving the lifetime characteristic of the battery.

In the exemplary embodiment of the present disclosure, the average particle diameter (D50) of the single particles is smaller than the average particle diameter (D50) of the secondary particles by 1 μm to 18 μm. For example, the average particle diameter (D50) of the single particles may be 1 μm to 16 μm smaller, 1.5 μm to 15 μm smaller, or 2 μm to 14 μm smaller than the average particle diameter (D50) of the secondary particles.

According to certain aspects, when the average particle diameter (D50) of the single particles is smaller than the average particle diameter (D50) of the secondary particles, for example, when the above range is satisfied, the single particles may have excellent particle strength even if they are formed with a small particle diameter, and as a result, the increase the phenomenon of micro-particles in an electrode due to particle breakage is alleviated, thereby improving the lifetime characteristic of the battery and the energy density.

According to a further exemplary embodiment of the present disclosure, the single particles are included in an amount of 15 parts by weight to 100 parts by weight based on 100 parts by weight of the positive electrode active material. The single particles may be included in an amount of 20 parts by weight to 100 parts by weight, or 30 parts by weight to 100 parts by weight based on 100 parts by weight of the positive electrode active material.

For example, the single particles may be included in an amount of 15 parts by weight or more, 20 parts by weight or more, 25 parts by weight or more, 30 parts by weight or more, 35 parts by weight or more, 40 parts by weight or more, or 45 parts by weight or more based on 100 parts by weight of the positive electrode active material. The single particles may be included in an amount of 100 parts by weight or less based on 100 parts by weight of the positive electrode active material.

According to certain aspects, when the single particles are included within the above range, excellent battery characteristics may be exhibited in combination with the negative electrode material described above. In particular, when the single particles are included in an amount of 15 parts by weight or more, according to certain aspects, the increase in the phenomenon of micro-particles in an electrode due to particle breakage in a roll-pressing process after fabrication of an electrode can be alleviated, thereby improving the lifetime characteristics of the battery.

In the exemplary embodiment of the present disclosure, the lithium composite transition metal compound may further include secondary particles, and the secondary particles may be included in an amount of 85 parts by weight or less based on 100 parts by weight of the positive electrode active material. The secondary particles may be included in an amount of 80 parts by weight or less, 75 parts by weight or less, or 70 parts by weight or less based on 100 parts by weight of the positive electrode active material. The secondary particles may be included in an amount of 0 part by weight or more based on 100 parts by weight of the positive electrode active material.

According to certain aspects, when the above range is satisfied, the above-described effects due to the existence of the single particles in the positive electrode active material can be maximized. In the case in which the positive electrode active material of the secondary particles is included, according to certain aspects, the components thereof may be the same as or different from those exemplified in the single-particle positive electrode active material described above, and may mean an aggregate form of single particles.

In the exemplary embodiment of the present disclosure, the positive electrode active material in 100 parts by weight of the positive electrode active material layer may be included in an amount of 80 parts by weight or more and 99.9 parts by weight or less, preferably 90 parts by weight or more and 99.9 parts by weight or less, more preferably 95 parts by weight or more and 99.9 parts by weight or less, most preferably 98 parts by weight or more and 99.9 parts by weight or less.

The positive electrode active material layer may include a positive electrode conductive material and a positive electrode binder together with the positive electrode active material described above.

In this case, the positive electrode conductive material is used to impart conductivity to the electrode, and can be used without particular limitation as long as the positive electrode conductive material has electronic conductivity without causing a chemical change in a battery to be constituted. Specific examples may include graphite such as natural graphite and artificial graphite; a carbon-based material such as carbon black, acetylene black, Ketjen black, channel black, furnace black, lamp black, thermal black and carbon fiber; metal powders or metal fibers such as copper, nickel, aluminum and silver; a conductive whisker such as zinc oxide and potassium titanate; a conductive metal oxide such as titanium oxide; or a conductive polymer such as polyphenylene derivative, or the like, and any one thereof or a mixture of two or more thereof may be used.

In addition, the positive electrode binder serves to improve bonding between particles of the positive electrode active material and adhesion between the positive electrode active material and the positive electrode current collector. Specific examples may include polyvinylidene fluoride (PVDF), vinylidene fluoride-hexafluoropropylene copolymer (PVDF-co-HFP), polyvinyl alcohol, polyacrylonitrile, carboxymethylcellulose (CMC), starch, hydroxypropylcellulose, regenerated cellulose, polyvinylpyrrolidone, polytetrafluoroethylene, polyethylene, polypropylene, ethylene-propylene-diene polymer (EPDM), sulfonated-EPDM, styrene butadiene rubber (SBR), fluoro rubber, or various copolymers thereof, and the like, and any one thereof or a mixture of two or more thereof may be used.

The separator serves to separate the negative electrode and the positive electrode and to provide a movement path of lithium ions, in which any separator may be used as the separator without particular limitation as long as it is typically used in a secondary battery, and particularly, a separator having high moisture-retention ability for an electrolyte as well as a low resistance to the movement of electrolyte ions may be preferably used. Specifically, a porous polymer film, for example, a porous polymer film manufactured from a polyolefin-based polymer, such as an ethylene homopolymer, a propylene homopolymer, an ethylene/butene copolymer, an ethylene/hexene copolymer, and an ethylene/methacrylate copolymer, or a laminated structure having two or more layers thereof may be used. In addition, a usual porous non-woven fabric, for example, a non-woven fabric formed of high melting point glass fibers, polyethylene terephthalate fibers, or the like may be used. Furthermore, a coated separator including a ceramic component or a polymer material may be used to secure heat resistance or mechanical strength, and the separator having a single layer or multilayer structure may be selectively used.

Examples of the electrolyte may include an organic liquid electrolyte, an inorganic liquid electrolyte, a solid polymer electrolyte, a gel-type polymer electrolyte, a solid inorganic electrolyte, or a molten-type inorganic electrolyte that may be used in the manufacturing of the lithium secondary battery, but are not limited thereto.

Specifically, the electrolyte may include a non-aqueous organic solvent and a metal salt.

As the non-aqueous organic solvent, for example, an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxy methane, dioxolane derivative, sulfolane, methyl sulfolane, 1,3-dimethyl-2-imidazolidinone, propylene carbonate derivative, tetrahydrofuran derivative, ether, methyl propionate, or ethyl propionate may be used.

In particular, among the carbonate-based organic solvents, ethylene carbonate and propylene carbonate, which are cyclic carbonates, are high-viscosity organic solvents and can be preferably used because they have high permittivity to dissociate a lithium salt well. When the cyclic carbonate is mixed with a linear carbonate with low viscosity and low permittivity, such as dimethyl carbonate and diethyl carbonate, in a suitable ratio and used, an electrolyte having high electric conductivity may be prepared, and therefore, may be more preferably used.

A lithium salt may be used as the metal salt, and the lithium salt is a material that is readily soluble in the non-aqueous electrolyte, in which, for example, one or more species selected from the group consisting of F⁻, Cl⁻, I⁻, NO₃⁻, N(CN)₂₋, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻ may be used as an anion of the lithium salt.

One or more additives, for example, a haloalkylene carbonate-based compound such as difluoroethylene carbonate, pyridine, triethylphosphite, triethanolamine, cyclic ether, ethylenediamine, n-glyme, hexamethyl phosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, may be further included in the electrolyte for the purpose of improving life characteristics of the battery, suppressing a decrease in battery capacity, improving discharge capacity of the battery, and the like, in addition to the above-described electrolyte components.

An exemplary embodiment of the present disclosure provides a battery module including the secondary battery as a unit cell, and a battery pack including the same. Since the battery module and the battery pack include the secondary battery having high capacity, high-rate capability, and high cycle characteristics, the battery module and the battery pack may be used as a power source of a medium to large sized device selected from the group consisting of an electric vehicle, a hybrid electric vehicle, a plug-in hybrid electric vehicle, and a power storage system.

### Mode for

Hereinafter, preferred examples will be provided for better understanding of the present disclosure. It will be apparent to one skilled in the art that the examples are only provided to illustrate the present disclosure and various modifications and alterations are possible within the scope and technical spirit of the present disclosure. Such modifications and alterations naturally fall within the scope of claims included herein.

### PREPARATION EXAMPLE

### Example 1

### Preparation of Negative Electrode

After silane gasification of a lump of silicon, which is MG-Si, a silicon-based active material was formed on a substrate through deposition by a chemical reaction. In this case, through process condition control (temperature condition ranging from 800° C. to 1100° C., pressure condition ranging from 10 pa to 150 pa), it was possible to control the crystal grain size of the silicon-based active material, and as a result, a silicon-based active material with a crystal grain size of 62 nm was prepared.

Thereafter, a negative electrode composition was formed using the silicon-based active material (Si, average particle diameter (D50): 3.5 μm, crystal grain size: 62 nm), the first conductive material, the second conductive material, and polyacrylamide as the binder at a weight ratio of 80:9.6:0.4:10, and then added to distilled water as a solvent for forming the negative electrode slurry, resulting in preparation of a negative electrode slurry.

The first conductive material was plate-like graphite (specific surface area: 17 m²/g, average particle diameter (D50): 3.5 μm, ratio of D50 to thickness: 28%) and the second conductive material was SWCNT (number of walls: 1 ea, average particle diameter: 1.6 μm, BET 1160 m²/g, IG/ID ratio: 143).

As a specific mixing method, after dispersing the conductive materials, the binder and water at 2500 rpm for 30 minutes with a homo mixer, the silicon-based active material was added to the dispersion, which was then dispersed at 2500 rpm for 30 minutes to fabricate a negative electrode slurry.

The negative electrode slurry was coated on both surfaces of a copper current collector (thickness: 8 μm) serving as a negative electrode current collector layer with a loading amount of 85 mg/25 cm², which was then roll-pressed and dried in a vacuum oven at 130° C. for 10 hours to form a negative electrode active material layer (thickness: 33 μm), whereby a negative electrode was prepared (thickness of negative electrode: 41 μm, porosity of negative electrode: 40.0%).

### Example 2

In Example 1, after silane gasification of a lump of silicon, which is MG-Si, a silicon-based active material was formed on a substrate through deposition by a chemical reaction. In this case, through process condition control (temperature condition ranging from 800° C. to 1100° C., pressure condition ranging from 10 pa to 150 pa), it was possible to control the crystal grain size of the silicon-based active material, and as a result, the same process as in Example 1 was performed, except that a silicon-based active material with a crystal grain size of 30 nm was prepared.

### Example 3

In Example 1, after silane gasification of a lump of silicon, which is MG-Si, a silicon-based active material was formed on a substrate through deposition by a chemical reaction. In this case, through process condition control (temperature condition ranging from 800° C. to 1100° C., pressure condition ranging from 10 pa to 150 pa), it was possible to control the crystal grain size of the silicon-based active material, and as a result, the same process as in Example 1 was performed, except that a silicon-based active material with a crystal grain size of 90 nm was prepared.

### Comparative Example 1

In Example 1, the cooling and gas deposition environments were changed when preparing a lump of silicon, which is MG-Si. Thereafter, a negative electrode was prepared in the same manner as in Example 1, except that the lump was pulverized using physical force, and as a result, a silicon-based active material with a crystal grain size of 212 nm was prepared and a silicon-based active material satisfying the above crystal grain size was used.

### Comparative Example 2

A negative electrode was prepared in the same manner as in Example 1, except that, in Example 1, a negative electrode composition was formed using the silicon-based active material (Si, average particle diameter (D50): 3.5 μm, crystal grain size: 62 nm), a particulate conductive material (carbon black), and polyacrylamide as a binder at a weight ratio of 80:10:10.

### Comparative Example 3

A negative electrode was prepared in the same manner as in Example 1, except that, in Example 1, a negative electrode composition was formed using the silicon-based active material (Si, average particle diameter (D50): 3.5 μm, crystal grain size: 62 nm), a first conductive material, and polyacrylamide as a binder at a weight ratio of 80:10:10.

### Comparative Example 4

A negative electrode was prepared in the same manner as in Example 1, except that, in Example 1, a negative electrode composition was formed using the silicon-based active material (Si, average particle diameter (D50): 3.5 μm, crystal grain size: 62 nm), a second conductive material, and polyacrylamide as a binder at a weight ratio of 84:0.5:15.5.

### Comparative Example 5

A negative electrode was prepared in the same manner as in Example 1, except that, in Example 1, a particulate conductive material (carbon black) was used as a conductive material, instead of the first conductive material.

### Comparative Example 6

A negative electrode was prepared in the same manner as in Example 1, except that, in Example 1, a negative electrode composition was formed using the silicon-based active material (Si, average particle diameter (D50): 3.5 μm, crystal grain size: 62 nm), a particulate conductive material (carbon black), a first conductive material, and polyacrylamide as a binder at a weight ratio of 80:5:5:10.

### Preparation of Secondary Battery

A positive electrode slurry (solid concentration: 78 wt %) was prepared by adding LiNi_{0.6}Co_{0.2}Mn_{0.2}O₂ (average particle diameter (D50): 15 μm) as a positive electrode active material, carbon black (product name: Super C65, manufacturer: Timcal) as a conductive material, and polyvinylidene fluoride (PVdF) as a binder to N-methyl-2-pyrrolidone (NMP) as a solvent for formation of a positive electrode slurry at a weight ratio of 97:1.5:1.5.

The positive electrode slurry was coated on both surfaces of an aluminum current collector (thickness: 12 μm) serving as a positive electrode current collector with a loading amount of 537 mg/25 cm², which was then roll-pressed and dried in a vacuum oven at 130° C. for 10 hours to form a positive electrode active material layer (thickness: 65 μm), whereby a positive electrode was prepared (thickness of the positive electrode: 77 μm, porosity: 26%).

A lithium secondary battery was prepared by interposing a polyethylene separator between the positive electrode and each of the negative electrodes of the Examples and the Comparative Examples and injecting an electrolyte.

The electrolyte was obtained by adding vinylene carbonate to an organic solvent, in which fluoroethylene carbonate (FEC) and diethyl carbonate (DEC) were mixed at a volume ratio of 30:70, in an amount of 3 wt % on the basis of a total weight of the electrolyte and adding LiPF₆ as a lithium salt to a concentration of 1M.

### EXPERIMENTAL EXAMPLE

### Experimental Example 1: Life Evaluation

For the lithium secondary batteries including the negative electrodes prepared in the Examples and Comparative Examples, the life and capacity retention rate were evaluated using an electrochemical charging and discharging device. The in-situ cycle test was conducted on the secondary battery at 4.2-3.2 V 1 C/1 C, and during the test, 1 C/1 C charging/discharging (4.2-3.2 V) was performed every 50 cycles to measure the capacity retention rate, and results thereof are listed in Table 1.

life retention rate (%)={(discharge capacity in the Nth cycle)/(discharge capacity in the first cycle)}×100

### Experimental Example 2: Evaluation of Resistance Increase Rate Measurement

In in Experimental Example 1, during the test, the capacity retention rate was measured by charging/discharging (4.2-3.0V) the battery at 0.33C/0.33C every 50 cycles, and then the resistance increase rate was compared and analyzed by discharging the battery with a pulse of 2.5C at SOC50 to measure the resistance. Results are shown in Table 1 below.

### Experimental Example 3: Volume Variation Due to Gas Generation Using Pouch Test

After fully charging a pouch cell with a capacity of 1 Ah at 0.33C to 4.2V for the lithium secondary batteries including the negative electrodes prepared in the Examples and Comparative Examples, the batteries were stored in the oven at 60° C. for 8 weeks. Thereafter, after full discharge to 2.5V, the gas generated in the pouch cell was extracted using a GC/MS method and gas quantitative analysis was performed, and results thereof are listed in Table 1 below.

TABLE 1

| | | Resistance | |
|---|---|---|---|
| | Capa. | Increase % | Gas volume |
| | Retention@500^{th} | @500^{th} | after storage |
| | 1 C/1 C Cycle, | 1 C/1 C Cycle, | test |
| | 4.2-3.2 V @25° C. | 4.2-3.2 V @25° C. | (mL/Ah) |
| Example 1 | 220^{th} | 20% | 3700 |
| Example 2 | 250^{th} | 10% | 3700 |
| Example 3 | 190^{th} | 40% | 3700 |
| Comparative | 170^{th} | 130% | 3700 |
| Example 1 | | | |
| Comparative | 80^{th} | 250% | 4000 |
| Example 2 | | | |
| Comparative | 50^{th} | 330% | 2300 |
| Example 3 | | | |
| Comparative | 130^{th} | 170% | 1400 |
| Example 4 | | | |
| Comparative | 130^{th} | 165% | 5400 |
| Example 5 | | | |
| Comparative | 50^{th} | 300% | 6300 |
| Example 6 | | | |

As can be seen in the Examples and Comparative Examples, the negative electrode composition according to aspects of the present disclosure uses the grain silicon-based active material within a specific range for increase in energy density to fabricate a negative electrode. In this case, it could be confirmed that for the negative electrode conductive material, the planar conductive material and the linear conductive material were used to greatly improve the electrical connectivity between the silicon-based active materials, resulting in preventing the electrical isolation phenomenon, which may occur when charging/discharging the negative electrode to which the silicon-based active material is applied, to improve the life of the negative electrode.

In the case of Comparative Example 1 in which the crystal grain size was outside the range according to aspects of the present disclosure, it could be confirmed that the strength of the silicon-based active material itself deteriorated to make it difficult to provide flexibility when included in the electrode, and the volume expansion could not be suppressed, resulting in a decrease in life performance and an increase in resistance.

In the case of Comparative Example 2 in which an excessive amount of particulate conductive material was included, there was room for improvement in life performance, but a high resistance increase rate was observed, and problems of increases in viscosity of the composition and amount of gas generation at high temperatures due to the high specific surface area occurred.

In the case of Comparative Examples 3 to 6 in which the crystal grain sizes were the same, but the planar and linear conductive materials were not used, unlike aspects of the present disclosure, it could be confirmed that the electrical connectivity could not be secured, resulting in poor life performance and high resistance increase rate.

In the case of Comparative Examples 2, 5, and 6 in which the particulate conductive material was used alone and the particulate and linear conductive materials or the particulate and planar conductive materials were used in combination, it could be confirmed that the particulate conductive material was included, resulting in the larger amounts of gas generation at high temperatures, as compared with the other Examples and Comparative Examples.

That is, the main feature of the negative electrode composition according to aspects of the present disclosure is that the negative electrode conductive material having specific composition and content as described above can be provided, leading to the construction of a system that can be provided together with the silicon-based active material with a high energy density.

1. A negative electrode composition comprising:
a silicon-based active material;
a negative electrode conductive material; and
a negative electrode binder,
wherein the silicon-based active material comprises 70 parts by weight or more of SiOx (x=0) based on 100 parts by weight of the silicon-based active material, and optionally comprises SiOx (0<x<2),
wherein the silicon-based active material has a crystal grain size of 200 nm or less, and
wherein the negative electrode conductive material comprises a planar conductive material and a linear conductive material.

2. The negative electrode composition of claim 1, wherein the silicon-based active material has a crystal grain size of 10 nm or greater and 150 nm or less.

3. The negative electrode composition of claim 1, wherein a D50 particle size of the silicon-based active material is 3 μm or greater and 10 μm or less.

4. The negative electrode composition of claim 1, wherein a surface area of the silicon-based active material is 0.25 m²/g or greater.

5. The negative electrode composition of claim 1, wherein the negative electrode composition has a viscosity of 1,000 cP or higher and 6,000 cP or less.

6. The negative electrode composition of claim 1, wherein the silicon-based active material is included in an amount of 60 parts by weight or more based on 100 parts by weight of the negative electrode composition.

7. The negative electrode composition of claim 1, wherein the negative electrode conductive material is included in an amount of 10 part by weight or more and 40 parts by weight or less based on 100 parts by weight of the negative electrode composition.

8. The negative electrode composition of claim 1, wherein the negative electrode conductive material includes 90 parts by weight or more and 99.9 parts by weight or less of the planar conductive material and 0.1 part by weight or more and 10 parts by weight or less of the linear conductive material based on 100 parts by weight of the negative electrode conductive material.

9. The negative electrode composition of claim 1, wherein the planar conductive material has D10 of 0.5 μm or greater and 1.5 μm or less, D50 of 2.5 μm or greater and 6.0 μm or less, and D90 of 7.0 μm or greater and 15.0 μm or less.

10. A negative electrode for a lithium secondary battery comprising:
a negative electrode current collector layer; and
a negative electrode active material layer comprising the negative electrode composition of claim 1 formed at least one surface of the negative electrode current collector layer.

11. The negative electrode for the lithium secondary battery of claim 10, wherein a thickness of the negative electrode current collector layer is 1 μm or greater and 100 μm or less, and
wherein a thickness of the negative electrode active material layer is 20 μm or greater and 500 μm or less.

12. A lithium secondary battery comprising:
a positive electrode;
the negative electrode for the lithium secondary battery of claim 10;
a separator provided between the positive electrode and the negative electrode; and
an electrolyte.
